(19) United States
(12) Patent Application Publication
(10) Pub. No.: US 2016/0132457 A1
(43) Pub. Date: May 12, 2016

(54) INTERCONNECT ASSEMBLY

(71) Applicant: HEWLETT PACKARD DEVELOPMENT COMPANY, L.P., Houston, TX (US)

(72) Inventors: ROBIN T. CASTELL, HOUSTON, TX (US); JAMES M MANN, HOUSTON, TX (US)

(21) Appl. No.: 14/770,807

(22) PCT Filed: Mar. 19, 2013
(86) PCT No.: PCT/US2013/032877

§ 371 Date: Aug. 26, 2015

(51) Int. Cl. G06F 13/42; G06F 13/40

(52) U.S. Cl. CPC G06F 13/4265; G06F 13/4068

(57) ABSTRACT

An interconnect assembly is disclosed herein. An example includes a cable including a first end and a cable head at the first end of the cable. The example also includes a wireless data transceiver disposed in the cable head to wirelessly communicate data to and from a device and a wireless power coupler disposed in the cable head to wirelessly supply power from the device to the wireless data transceiver.

### BACKGROUND

Consumers appreciate ease of use and reliability in their devices. They also appreciate aesthetically pleasing designs. Businesses may, therefore, endeavor to create and provide devices directed toward one or more of these objectives.

### BRIEF DESCRIPTION OF THE DRAWINGS

The following detailed description references the drawings, wherein:

FIG. 1 is an example of an interconnect assembly.

FIG. 2 is an example of additional components or elements of the interconnect assembly of FIG. 1.

FIG. 3 is an example of a daisy chained interconnect assembly.

FIG. 4 is another example of a daisy chained interconnect assembly.

FIG. 5 is an example illustrating a type of connection for a second end of a cable of the interconnect assembly of FIG. 1.

FIG. 6 is an example illustrating another type of connection for the second end of the cable of the interconnect assembly of FIG. 1.

FIG. 7 is an example illustrating some of the various types of technologies that may be used by the wireless power coupler of the interconnect assembly of FIG. 1.

FIG. 8 is an example illustrating an attachment and alignment mechanism in use with the interconnect assembly of FIG. 1.

### DETAILED DESCRIPTION

Interconnect assemblies may include various mechanical components or elements, such as prongs, plugs, pins, or clips, which matingly engage a corresponding socket, aperture, opening or receptacle during connection. Examples of such interconnect assemblies include various cable assemblies (e.g., Universal Serial Bus, Video Graphics Array, High Definition Multimedia Interface, IEEE 1394, etc.) for use with devices, such as computers, tablets, mobile phones, televisions, and personal digital assistants.

The mechanical parts of these interconnect assemblies can be subject to damage and/or fatigue which can compromise the integrity of a connection. Additionally, dirt, debris, moisture, and other contaminants may collect on or enter such interconnect assemblies and their corresponding sockets, apertures, openings or receptacles which can render them, and/or any devices to which they are connected, inoperable. Furthermore, such interconnect assemblies and their corresponding sockets, apertures, openings and receptacles may detract from the aesthetics of a device for at least some consumers.

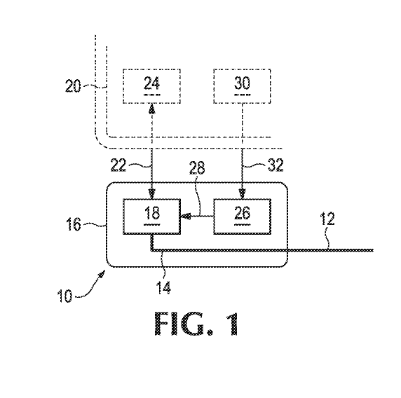

An example of an interconnect assembly 10 that is directed to addressing these challenges is illustrated in FIG. 1. As used herein, the term “cable” is defined as including, but is not necessarily limited to, either (i) one or more wires or cables that transceive data in the form of signals and that may be covered or bound together by a sleeve, insulation, conduit, tape, straps, etc. or (ii) a dongle.

As used herein, the term “dongle” is defined as including, but is not necessarily limited to, an apparatus that provides additional or enhanced functionality (e.g., additional memory, wireless connectivity, etc.) or an apparatus that facilitates the interface or connection between two different types of adapters, protocols, or power sources. Examples of dongles include, but are not limited to, flash memories, secure keys, and connection adapters. As used herein, the term “device” is defined as including, but is not necessarily limited to, a computer, tablet, mobile phone, television, personal digital assistant, monitor, display, audio component, peripheral, dock, sleeve, docking station, or appliance.

As used herein, the term “transceiver” is defined as including both transmission and reception of data in the form of one or more signals. As used herein, the terms “wireless” and “wirelessly” are defined as including, but are not necessarily limited to, a connection or coupling that does not require mechanical components or elements such as prongs, plugs, pins, or clips that matingly engage a corresponding socket, aperture, opening or receptacle. Wireless connections and couplings may operate in any of a variety of different frequency ranges and wavelengths. They may also be established electrically, magnetically, or optically.

Referring again to FIG. 1, interconnect assembly 10 includes a cable 12 having a first end 14 and a cable head 16 at first end 14 of cable 12. Interconnect assembly 10 also includes a wireless data transceiver 18 disposed in cable head 16 to wirelessly communicate data to and from device 20, as generally indicated by double-headed arrow 22 and wireless data transceiver 24 of device 20. As can be seen in FIG. 1, wireless data transceiver 18 is coupled to first end 14 of cable 12. Interconnect assembly 10 additionally includes a wireless power coupler 26 disposed in cable head 16 to wirelessly supply power from device 20 to wireless data transceiver 18, as generally indicated by arrow 28. As can also be seen in FIG. 1, device 20 includes a power supply 30 that wirelessly transmits power to wireless power coupler 26, as generally indicated by arrow 32.

In this example, cable head 16 provides a substantially fluid tight enclosure for wireless data transceiver 18 and wireless power coupler 26 to protect them from dirt, debris, moisture, etc. during use. Additionally, wireless data transceiver 18 and wireless power coupler 26 eliminate the issues, described above, associated with interconnect assemblies that utilize mechanical components.

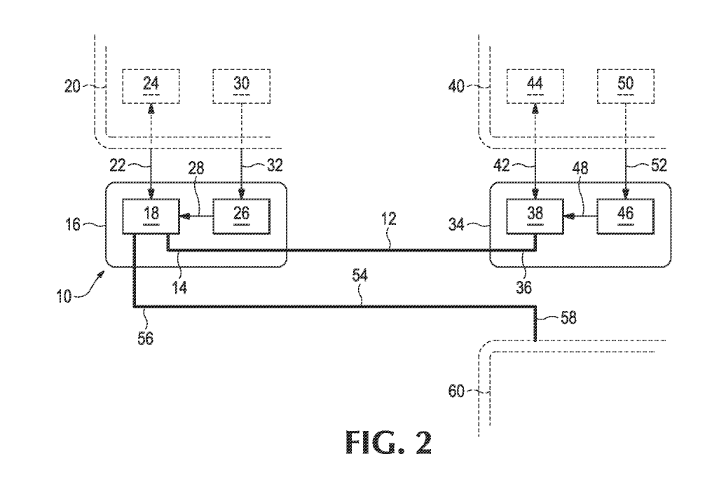

An example of additional components or elements of interconnect assembly 10 is shown in FIG. 2. As can be seen in FIG. 2, interconnect assembly 10 may also include a second cable head 34 at second end 36 of cable 12 and a second wireless data transceiver 38 disposed in second cable head 34 to wirelessly communicate data to and from second device 40, as generally indicated by double-headed arrow 42 and wireless data transceiver 44 of second device 40. In this example, second wireless data transceiver 38 is coupled to second end 36 of cable 12. Interconnect assembly 10 additionally includes a second wireless power coupler 46 disposed in second cable head 34 to wirelessly supply power from second device 40 to wireless data transceiver 38, as generally indicated by arrow 48. As can also be seen in FIG. 2, second device 40 includes a power supply 50 that wirelessly transmits power to second wireless power coupler 46, as generally indicated by arrow 52.

In this example, second cable head 34 provides a substantially fluid tight enclosure for second wireless data transceiver 38 and second wireless power coupler 46 to protect them from dirt, debris, moisture, etc. during use. Additionally, second wireless data transceiver 38 and second wireless power coupler 46 eliminate the issues, described above, associated with interconnect assemblies that utilize mechanical components.

As can additionally be seen in FIG. 2, interconnect assembly 10 may include a second cable 54 having a third end 56 that is coupled to wireless data transceiver 18. Second cable 54 also includes a fourth end 58 to couple to third device 60. Fourth end 58 may be coupled to a wireless data transceiver (not shown) of third device 60 or, for example, it may be directly connected to an input/output controller (also not shown) of third device 60.

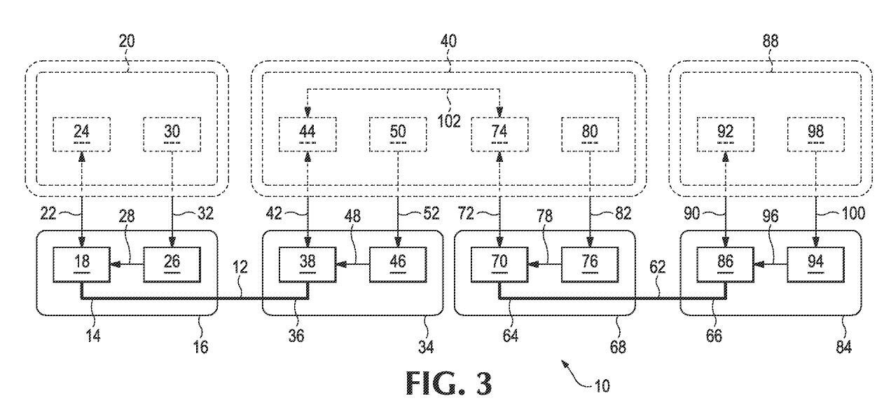

An example of daisy chaining interconnect assembly 10 is shown in FIG. 3. As can be seen in FIG. 3, in this example, interconnect assembly 10 includes a second cable 62 having a third end 64 and a fourth end 66, and a third cable head 68 at third end 64 of second cable 62. Interconnect assembly 10 also includes a third wireless data transceiver 70 disposed in third cable head 68 to wireless communicate data to and from second device 40, as generally indicated by double-headed arrow 72 and wireless data transceiver 74 of second device 40, and a third wireless power coupler 76 disposed in third cable head 68 to wirelessly supply power from second device 40 to third wireless data transceiver 70, as generally indicated by arrow 78. In this example, second device 40 includes a power supply 80 that wirelessly transmits power to third wireless power coupler 76, as generally indicated by arrow 82. It is to be understood, however, that in other examples, power supply 50 of second device 40 may be utilized to also wirelessly transmit power to third power coupler 76.

As can also be seen in FIG. 3, interconnect assembly 10 includes a fourth cable head 84 at fourth end 66 of second cable 62 and a fourth wireless data transceiver 86 disposed in fourth cable head 84 to wirelessly communicate data to and from third device 88, as generally indicated by double-headed arrow 90 and wireless data transceiver 92 of third device 88. Interconnect assembly 10 additionally includes a fourth wireless power coupler 94 disposed in fourth cable head 84 to wirelessly supply power from third device 88 to fourth wireless data transceiver 86, as generally indicated by arrow 96. As can additionally be seen in FIG. 3, device 88 includes a power supply 98 that wirelessly transmits power to fourth wireless power coupler 94, as generally indicated by arrow 100.

In this example, respective third and fourth cable heads 68 and 84 provide substantially fluid tight enclosures for third and fourth wireless data transceivers 70 and 86, as well as for third and fourth wireless power couplers 76 and 94 to protect them from dirt, debris, moisture, etc. during use. Additionally, third and fourth wireless data transceivers 70 and 86, as well as third and fourth wireless power couplers 76 and 94 eliminate the above-described issues associated with interconnect assemblies that utilize mechanical components.

As can further be seen in FIG. 3, this daisy chained arrangement of interconnect assembly 10 allows data to be wirelessly communicated between each of devices 20, 40, and 88. In the specific case of data communication between first device 20 and third device 88, wireless data transceivers 44 and 74 are coupled or connected together, as generally indicated by dashed double-headed arrow 102, to provide a path or bridge for this communication. Although not shown in FIG. 3, it is to be understood that any number of additional devices may wirelessly communicate using the illustrated daisy-chained interconnect assembly arrangement. Depending on the number of such additional devices, further cables, cable heads, wireless data transceivers, and/or wireless power couplers may be needed.

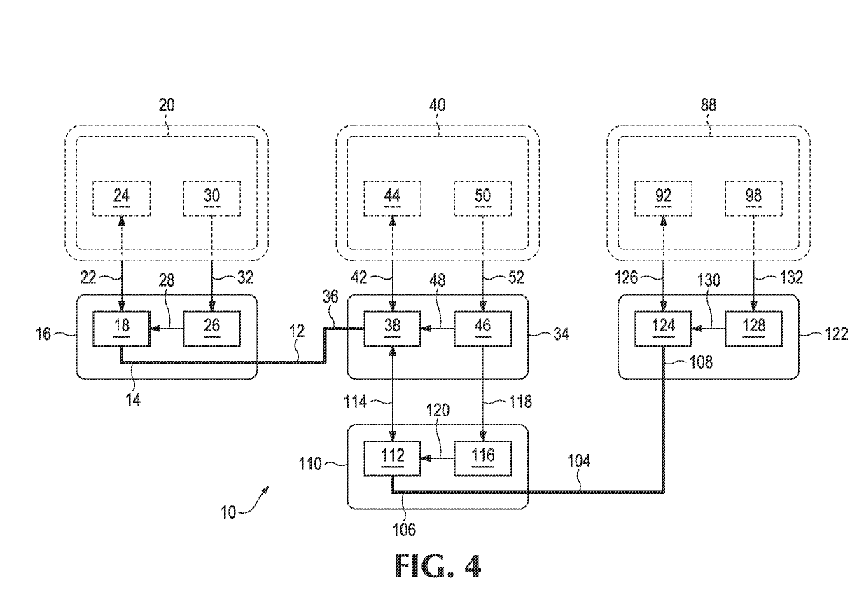

Another example of daisy chaining interconnect assembly 10 is shown in FIG. 4. As can be seen in FIG. 4, in this example, interconnect assembly 10 includes a second cable 104 having a third end 106 and a fourth end 108, and a third cable head 110 at third end 106 of second cable 104. Interconnect assembly 10 also includes a third wireless data transceiver 112 disposed in third cable head 110 to wirelessly communicate data to and from second wireless data transceiver 38, as generally indicated by double-headed arrow 114, and a third wireless power coupler 116 disposed in third cable head 110 to wirelessly supply power from second wireless power coupler 46, as generally indicated by arrow 118, to third wireless data transceiver 112, as generally indicated by arrow 120.

As can also be seen in FIG. 4, interconnect assembly 10 includes a fourth cable head 122 at fourth end 108 of second cable 104 and a fourth wireless data transceiver 124 disposed in fourth cable head 122 to wirelessly communicate data to and from third device 88, as generally indicated by double-headed arrow 126 and wireless data transceiver 92 of third device 88. Interconnect assembly 10 additionally includes a fourth wireless power coupler 128 disposed in fourth cable head 122 to wirelessly supply power from third device 88 to fourth wireless data transceiver 124, as generally indicated by arrow 130. As can additionally be seen in FIG. 4, device 88 includes a power supply 98 that wirelessly transmits power to fourth wireless power coupler 128, as generally indicated by arrow 132.

In this example, respective third and fourth cable heads 110 and 122 provide substantially fluid tight enclosures for third and fourth wireless data transceivers 112 and 124, as well as for third and fourth wireless power couplers 116 and 128 to protect them from dirt, debris, moisture, etc. during use. Additionally, third and fourth wireless data transceivers 112 and 124, as well as third and fourth wireless power couplers 116 and 128 eliminate the above-described issues associated with interconnect assemblies that utilize mechanical components.

As can further be seen in FIG. 4, this daisy chained arrangement of interconnect assembly 10 allows data to be wirelessly communicated between each of devices 20, 40, and 88. Although not shown in FIG. 4, it is to be understood that any number of additional devices may wirelessly communicate using the illustrated daisy-chained interconnect assembly arrangement. Depending on the number of such additional devices, further cables, cable heads, wireless data transceivers, and/or wireless power couplers may be needed.

In some examples, one or more of wireless data transceivers 18, 38, 70, 86, 112, and 124 of interconnect assembly 10 may operate in the extremely high frequency (EHF) range. In other examples, one or more of wireless data transceivers 18, 38, 70, 86, 112, and 124 of interconnect assembly 10 may operate substantially at sixty (60) gigahertz (GHz). In still other examples, one or more of wireless data transceivers 18, 38, 70, 86, 112, and 124 of interconnect assembly 10 may operate substantially in an infrared frequency range.

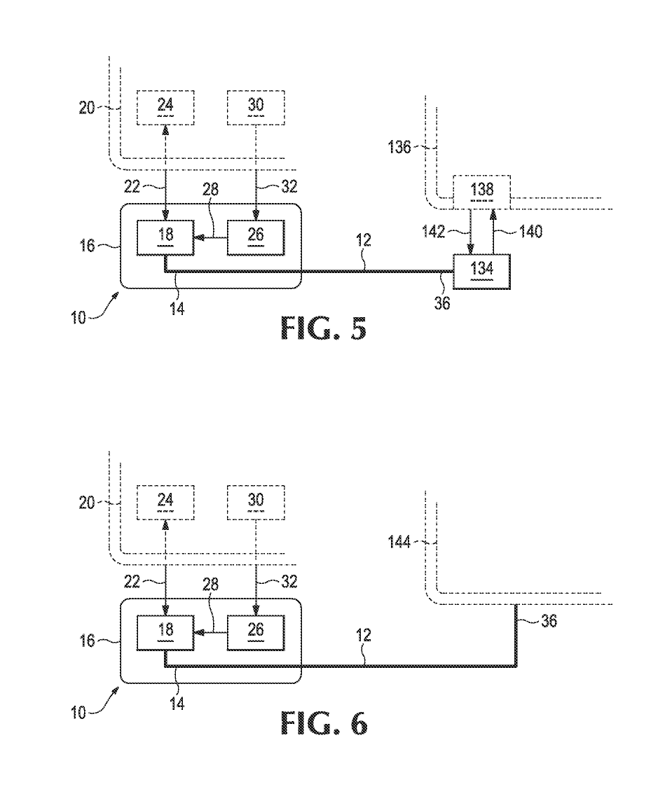

An example of a type of connection for second end 36 of cable 12 of interconnect assembly 10 is illustrated in FIG. 5. As can be seen in FIG. 5, interconnect assembly 10 further includes a connector 134 at second end 36 of cable 12 to couple to a second device 136. More specifically, connector 134 is designed to plug into a socket, aperture or opening 138, as generally indicated by arrow 140. Connector 134 is also designed to unplug from socket, aperture or opening 138 by moving it in a direction generally indicated by arrow 142. Connector 134 may include any type configuration or design depending on the type of technology being used (e.g., Universal Serial Bus, Video Graphics Array, High Definition Multimedia Interface, IEEE 1394, etc.).

Another example of a type of connection for second end 36 of cable 12 of interconnect assembly 10 is illustrated in FIG. 6. As can be seen in FIG. 6, in this example, second end 36 of cable 12 is hard wired to a second device 144. More specifically, second end 36 is permanently retained or attached to second device 144 and is not intended to be removed by an end-user of device 144. This type of connection may be established in a variety of different ways such as, for example, directly soldering second end 36 to an inputioutput controller of second device 144 or through the use of a connector at second end 36 of cable 12 that is held captive by second device 144.

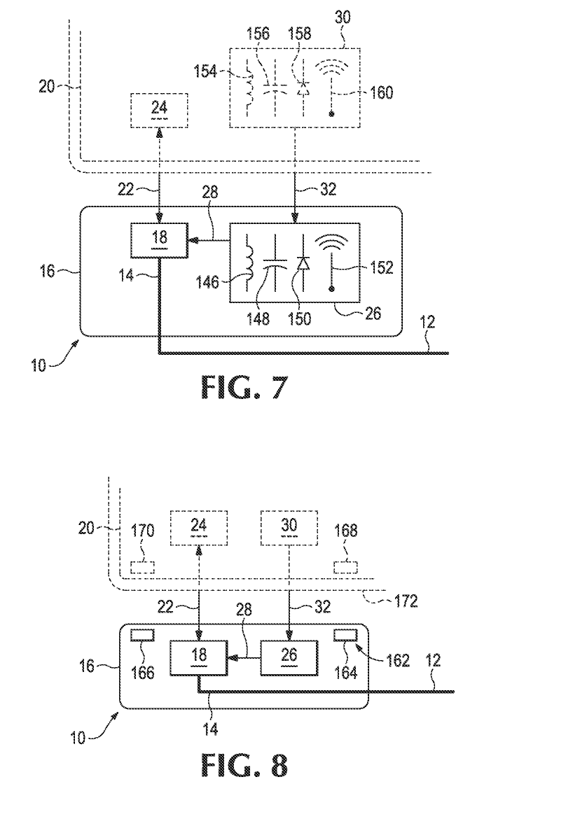

An example illustrating some of the various types of technologies that may be used by wireless power coupler 26 of interconnect assembly 10 is shown in FIG. 7. As can be seen in FIG. 7, wireless power coupler 26 may utilize inductive 146, capacitive 148, optical 150, and/or radio frequency (RF) 152 coupling to wirelessly supply power from device 20 to wireless data transceiver 18. As can also be seen in FIG. 7, power supply 30 of device 20 includes corresponding technology to wirelessly transmit power to wireless power coupler 26, as generally indicated by arrow 32 and inductor 154, capacitor 156, light emitting diode (LED) 158, and radio transceiver 160. Although not shown in FIG. 7, it is to be understood that one or more of wireless power couplers 46, 76, 94, 116, and 128 and corresponding power supply 50, 80, and 98 may also use any of these various technologies.

An example illustrating an attachment and alignment mechanism 162 in use with interconnect assembly 10 is shown in FIG. 8. Alignment and attachment mechanism 162 helps to facilitate connection of cable head 16 to device 20 as a result of the attraction between magnets 164 and 166 in cable head 16 and magnets 168 and 170 in device 20. Attachment and alignment mechanism 162 also facilitates wireless communication between wireless data transceiver 18 and wireless data transceiver 24 by helping to maintain their proper relative positions. Alignment and attachment mechanism 162 additionally facilitates wireless supply of power from device 20 to wireless power coupler 26 by helping to maintain proper relative positioning between power supply 30 and wireless power coupler 26.

Although a pair of magnets 164 and 166 in cable head 16 and a pair of magnets 168 and 170 in device 20 are shown in the example of attachment and alignment mechanism 162 of FIG. 8, it is to be understood that, in other examples, a different number may be used. For example, only one magnet in cable head 16 and one magnet in device 20. As another example, where cable head 16 is made from a magnetic material, only one or more magnets may be needed in device 20. As an additional example, where base 172 of device 20 is made from a magnetic material, only one or more magnets may be needed in cable head 16. Additionally, although not shown in FIG. 8, it is to be understood that one or more of cable heads 34, 68, 84, 110, and 122 and/or devices 40, 60, 88, 136, and 144 may also include an alignment and attachment mechanism.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. An interconnect assembly, comprising:
a cable including a first end;
a cable head at the first end of the cable;
a wireless data transceiver disposed in the cable head to wirelessly communicate data to and from a device; and
a wireless power coupler disposed in the cable head to wirelessly supply power from the device to the wireless data transceiver.

2. The interconnect assembly of claim 1, wherein the cable includes a second end and further comprising:
a second cable head at the second end of the cable;
a second wireless data transceiver disposed in the second cable head to wirelessly communicate data to and from a second device; and
a second wireless power coupler disposed in the second cable head to wirelessly supply power from the second device to the second wireless data transceiver.

3. The interconnect assembly of claim 2, further comprising a second cable including a third end coupled to the wireless data transceiver and a fourth end to couple to a third device.

4. The interconnect assembly of claim 2, further comprising:
a second cable including a third end and a fourth end;
a third cable head at the third end of the second cable;
a third wireless data transceiver disposed in the third cable head to wirelessly communicate data to and from the second device;
a third wireless power coupler disposed in the third cable head to wirelessly supply power from the second device to the third wireless data transceiver;
a fourth cable head at the fourth end of the second cable;
a fourth wireless data transceiver disposed in the fourth cable head to wirelessly communicate data to and from a third device; and
a fourth wireless power coupler disposed in the fourth cable head to wirelessly supply power from the third device to the fourth wireless data transceiver.

5. The interconnect assembly of claim 2, further comprising:
a second cable including a third end and a fourth end;
a third cable head at the third end of the second cable;
a third wireless data transceiver disposed in the third cable head to wirelessly communicate data to and from the second wireless data transceiver;
a third wireless power coupler disposed in the third cable head to wirelessly supply power from the second wireless power coupler to the third wireless data transceiver;
a fourth cable head at the fourth end of the second cable;
a fourth wireless data transceiver disposed in the fourth cable head to wirelessly communicate data to and from a third device; and
a fourth wireless power coupler disposed in the fourth cable head to wirelessly supply power from the third device to the fourth wireless data transceiver.

6. The interconnect assembly of claim 1, wherein the wireless data transceiver operates in an extremely high frequency (EHF) range.

7. The interconnect assembly of claim 1, wherein the wireless data transceiver operates substantially at sixty (60) gigahertz (GHz).

8. The interconnect assembly of claim 1, wherein the wireless data transceiver operates substantially in an infrared frequency range.

9. The interconnect assembly of claim 1, wherein the cable includes a second end and further comprising a connector at the second end of the cable to couple to a second device.

10. The interconnect assembly of claim 1, wherein the cable includes a second end, and further wherein the second end is hard wired to a second device.

11. The interconnect assembly of claim 1, wherein the wireless power coupler utilizes at least one of inductive, capacitive, optical, and radio frequency coupling to wirelessly supply power from the device to the wireless data transceiver.

12. The interconnect assembly of claim 1, further comprising an attachment mechanism to facilitate connection of the cable head to the device.

13. The interconnect assembly of claim 12, wherein the attachment mechanism includes a magnet in at least one of the cable head and the device.

14. The interconnect assembly of claim 1, further comprising an alignment mechanism to facilitate at least one of wireless communication of data to and from the device and wireless supply of power from the device to the wireless power coupler.

15. The interconnect assembly of claim 14, wherein the alignment mechanism includes a magnet in at least one of the cable head and the device.
